(19) United States
(12) Patent Application Publication
(10) Pub. No.: US 2025/0018967 A1
(43) Pub. Date: Jan. 16, 2025

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventor: Hiroyuki NAKAZONO, Toyota-shi (JP)

(73) Assignee: TOYOTA JIDOSHA KABUSHIKI KAISHA, Tokyo-shi (JP)

(21) Appl. No.: 18/734,397

(22) Filed: Jun. 5, 2024

(30) Foreign Application Priority Data
Jul. 11, 2023 (JP) 2023-114022

(51) Int. Cl. B60W 50/14; G01C 21/30; G08G 1/056; H04W 4/46

(52) U.S. Cl. CPC B60W 50/14; G01C 21/30; G08G 1/056; H04W 4/46; B60W 2554/4044; B60W 2554/805

(57) ABSTRACT

The information processing device includes a control unit that determines a traveling lane in which the host vehicle and the target vehicle travel from position information of the host vehicle and the target vehicle and map information, determines a traveling direction of the target vehicle with respect to the host vehicle from a difference in traveling azimuth angle of the host vehicle and the target vehicle, and outputs alert information corresponding to a determination result of the traveling lane and the traveling direction of the target vehicle.

### CROSS-REFERENCE TO RELATED APPLICATION

This application claims priority to Japanese Patent Application No. 2023-114022 filed on Jul. 11, 2023, incorporated herein by reference in its entirety.

### BACKGROUND

### 1. Technical Field

The present disclosure relates to an information processing device and an information processing method.

### 2. Description of Related Art

There has hitherto been known a technique of reporting a positional relationship of a surrounding vehicle. For example, Japanese Unexamined Patent Application Publication No. 2020-188406 (JP 2020-188406 A) discloses a technique of reporting a positional relationship of a surrounding vehicle to a driver through vehicle-to-vehicle communication using a server that provides map information.

### SUMMARY

According to JP 2020-188406 A, it is possible to detect a vehicle traveling the wrong way while traveling on a one-way road. However, J P 2020-188406 A does not disclose a technique of detecting whether a vehicle approaching from the front is traveling in the same lane as the host vehicle on a road with a plurality of lanes.

Thus, there is room for improvement in the technique of reporting a positional relationship of a surrounding vehicle.

An object of the present disclosure made in view of such circumstances is to improve a technique of reporting a positional relationship of a surrounding vehicle.

An aspect of the present disclosure provides an information processing device mounted on a vehicle, including a control unit that determines respective traveling lanes in which a host vehicle and a target vehicle travel from position information on the host vehicle and the target vehicle and map information, determines a traveling direction of the target vehicle with respect to the host vehicle from a difference between respective traveling azimuth angles of the host vehicle and the target vehicle, and outputs attention seeking information corresponding to a determination result of the traveling lanes and the traveling direction of the target vehicle.

An aspect of the present disclosure provides an information processing method executed by an information processing device mounted on a vehicle, including: determining respective traveling lanes in which a host vehicle and a target vehicle travel from position information on the host vehicle and the target vehicle and map information; determining a traveling direction of the target vehicle with respect to the host vehicle from a difference between respective traveling azimuth angles of the host vehicle and the target vehicle; and outputting attention seeking information corresponding to a determination result of the traveling lanes and the traveling direction of the target vehicle.

According to an embodiment of the present disclosure, a technique of reporting a positional relationship of a surrounding vehicle is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration example of a system according to an embodiment of the present disclosure;

FIG. 2 is a block diagram illustrating a schematic configuration example of an information processing device;

FIG. 3 is a flow chart illustrating an exemplary operation of the information processing device; and

FIG. 4 is a schematic diagram illustrating an example of a traveling azimuth angle of a host vehicle and a target vehicle.

### DETAILED DESCRIPTION OF EMBODIMENTS

Hereinafter, an embodiment of the present disclosure will be described.

### Outline of Embodiment

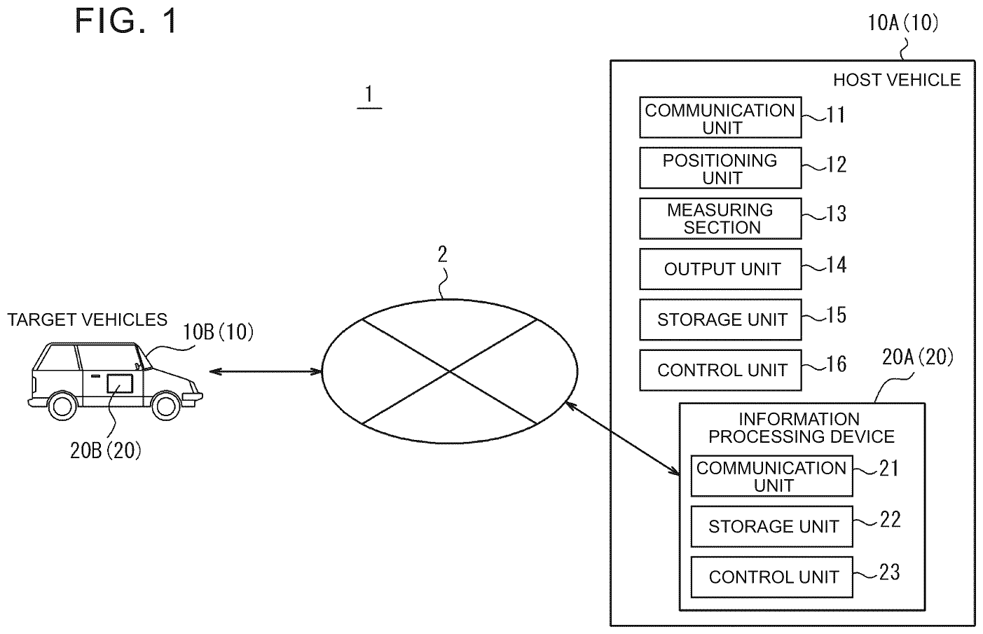

The outline of a system 1 according to an embodiment of the present disclosure will be described with reference to FIG. 1. The system 1 includes a vehicle 10 and an information processing device 20 provided in the vehicle 10.

The vehicle 10 is, for example, an automobile, but is not limited to this, and may be any vehicle. Vehicles include, but are not limited to, gasoline-powered vehicles, Battery Electric Vehicle (BEV), Hybrid Electric Vehicle (HEV), Plug-in Hybrid Electric Vehicle (PHEV), or Fuel Cell Electric Vehicle (FCEV). In the present embodiment, the vehicle 10 is a host vehicle 10A or a target vehicle 10B that travels on a road having one or more traveling lanes. The number of the target vehicles 10B may be arbitrarily determined. The vehicles 10 and the information processing device 20 are wired by Controller Area Network (CAN) or the like, but the standard of the wired connection is not limited thereto.

The information processing device 20 is, for example, a computer. The host vehicle 10A includes an information processing device 20A, and the target vehicle 10B includes an information processing device 20B. The information processing device 20A and the information processing device 20B are the same information processing device. The information processing device 20A and the information processing device 20B are wirelessly connected via the network 2. The network 2 is an inter-vehicle communication network, but the communication network is not limited thereto. The network 2 may be an Internet communication network or a mobile communication network.

First, the outline of the present embodiment will be described, and the details will be described later. The information processing device 20 determines the traveling lane in which the host vehicle 10A and the target vehicle 10B travel from the position information of the host vehicle 10A and the position information of the target vehicle 10B and the map information, determines the traveling direction of the target vehicle 10B with respect to the host vehicle 10A from the differences in the traveling azimuth angles of the host vehicle 10A and the target vehicle 10B, and outputs alert information according to the determination result of the traveling direction of the traveling lane and the target vehicle 10B.

As described above, according to the present embodiment, for example, the information processing device 20A can determine the host vehicle 10A and the traveling lane and the traveling direction in which the target vehicle 10B travels on a road having one or more traveling lanes, respectively, and can output the alert information corresponding to the determination result to the output unit 14 in the vehicle cabin of the host vehicle 10A. Therefore, when the target vehicle 10B approaches the same traveling lane from the front toward the host vehicle 10A, the driver of the host vehicle 10A can detect that the target vehicle 10B traveling backward is approaching. Therefore, a technique of reporting the positional relation of the surrounding vehicles is improved in that the driver of the host vehicle 10A takes an action of avoiding danger such as lane change, thereby improving the possibility of avoiding an automobile accident.

Next, each configuration of the system 1 will be described in detail.

### Configuration of Vehicle

As illustrated in FIG. 1, the vehicle 10 includes a communication unit 11, a positioning unit 12, a measurement unit 13, an output unit 14, a storage unit 15, a control unit 16, and an information processing device 20. A detailed description of the information processing device 20 will be described later.

The communication unit 11 includes one or more communication interfaces wired to the communication unit 21 of the information processing device 20. The communication interfaces correspond to, for example, communication standards such as CAN, but are not limited thereto.

The positioning unit 12 includes one or more devices that acquire position information of the vehicle 10. Specifically, the positioning unit 12 includes, for example, a receiver corresponding to GPS, but is not limited thereto, and may include a receiver corresponding to any satellite-based positioning system.

The measurement unit 13 includes one or more sensors. The measurement unit 13 may include a gyro sensor, an acceleration sensor, a geomagnetic sensor, an atmospheric pressure sensor, and the like. However, the sensor is not limited thereto.

The output unit 14 is configured to include at least one audio output interface capable of outputting audio and at least one display interface capable of displaying text or video. The audio output interface is, for example, a speaker. The display interfaces are, for example, displays such as LCD or organic EL displays. The audio output interface and the display interface are not limited thereto. The output unit 14 outputs the alert information received from the information processing device 20 to the vehicle cabin.

The storage unit 15 includes one or more memories. The memories are, for example, a semiconductor memory, a magnetic memory, or an optical memory, but are not limited to these memories. Each memory included in the storage unit 15 may function as, for example, a main storage device, an auxiliary storage device, or a cache memory. The storage unit 15 stores any type of information that is used for the operation of the vehicle 10. For example, the storage unit 15 may store a system program, an application program, embedded software, map information, and the like. The map information includes road information covering the entire country or a predetermined area, position information of a traveling lane of each road, and the like. The information stored in the storage unit 15 may be updatable by, for example, information acquired from the network 2 via the communication unit 11.

The control unit 16 includes one or more processors, one or more programmable circuits, one or more dedicated circuits, or a combination of these. The processor may be, but is not limited to, a general-purpose processor such as, for example, Central Processing Unit (CPU) or Graphics Processing Unit (GPU), or a special-purpose 15 processor specialized for a particular process. The programmable circuitry is, for example, but not limited to, Field-Programmable Gate Array (FPGA). The dedicated circuitry is, for example, but not limited to, Application Specific Integrated Circuit (ASIC). The control unit 16 controls the operation of the entire vehicle 10.

### Configuration of Information Processing Device

As illustrated in FIG. 1, the information processing device 20 includes a communication unit 21, a storage unit 22, and a control unit 23.

The communication unit 21 includes both a communication interface connected to the network 2 and a communication interface connected to CAN. The communication interfaces connected to the network 2 correspond to, for example, an inter-vehicle communication standard (for example, Vehicle-to-Everything (V2X)), a mobile communication standard, or the like, but are not limited thereto, and may correspond to any communication standard. In the present embodiment, the information processing device 20A of the host vehicle 10A is wirelessly connected to the information processing device 20B of the target vehicle 10B via the communication unit 21 and the network 2. On the other hand, the information processing device 20A is wired to the communication unit 11 of the host vehicle 10A via the communication unit 21 via a CAN or the like. Further, the information processing device 20B is wired to the communication unit 11 of the target vehicle 10B via the communication unit 21 by a CAN or the like.

The storage unit 22 includes one or more memories. Each memory included in the storage unit 22 may function as, for example, a main storage device, an auxiliary storage device, or a cache memory. The storage unit 22 stores any information used for the operation of the information processing device 20. For example, the storage unit 22 may store a system program, an application program, a database, and map information. The map information includes road information covering the entire country or a predetermined area, position information of a traveling lane of each road, and the like. The information stored in the storage unit 22 may be updatable by, for example, information acquired from the network 2 via the communication unit 21.

The control unit 23 includes one or more processors, one or more programmable circuits, one or more dedicated circuits, or a combination thereof. The control unit 23 controls the operation of the information processing device 20 as a whole.

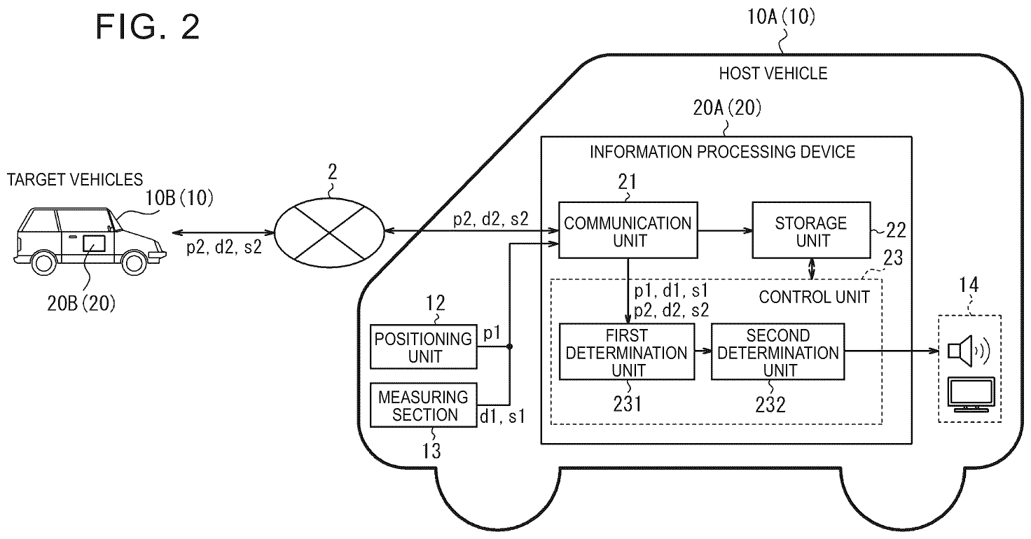

As illustrated in FIG. 2, in the present embodiment, the control unit 23 functions as the first determination unit 231 and the second determination unit 232.

The first determination unit 231 determines a traveling lane in which the host vehicle 10A and the target vehicle 10B travel based on the position information of the host vehicle 10A and the target vehicle 10B and the map information. The first determination unit 231 outputs the determination result of the traveling lane, the vehicle speed and the traveling azimuth angle of the host vehicle 10A, and the vehicle speed and the traveling azimuth angle of the target vehicle 10B to the second determination unit 232.

The second determination unit 232 determines the traveling direction of the target vehicle 10B with respect to the host vehicle 10A from the differences between the traveling azimuth angles of the host vehicle 10A and the target vehicle 10B received from the first determination unit 231. The second determination unit 232 outputs, to the output unit 14 of the vehicle 10, the alert information corresponding to the determination result of the traveling direction of the target vehicle 10B with respect to the traveling lane and the host vehicle 10A.

### Operation Flow of Information Processing Device

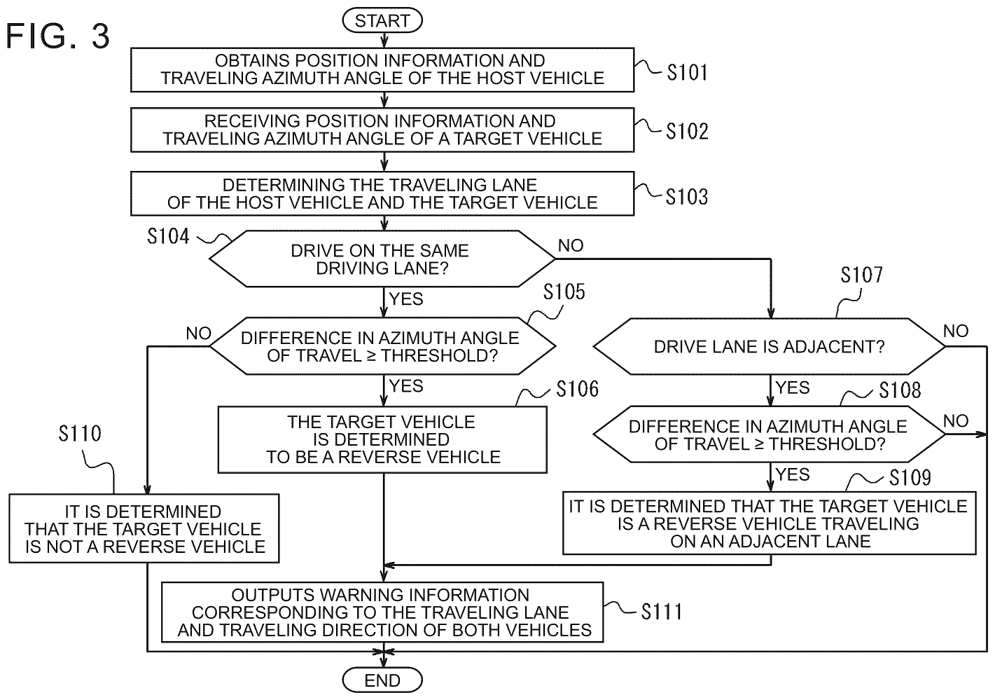

An operation of the information processing device 20 according to the present embodiment will be described with reference to FIG. 3. This operation relates to the host vehicle 10A and the outputting of reminder information corresponding to the traveling lane and the traveling direction of the target vehicle 10B.

In S101, the control unit 23 acquires the position information p1, the vehicle speed s1, and the traveling azimuth angle d1 of the host vehicle 10A.

The positioning unit 12 of the host vehicle 10A acquires the position data of the host vehicle 10A by the receiver corresponding to GPS or the quasi-zenith satellites, for example, and acquires p1 of the position data. The quasi-zenith satellite system using the quasi-zenith satellite “Michibiki” enables the improvement of the positioning accuracy to cm class independently compared with GPS which was an error of the degree from 5 m to 10 m until now by transmitting the reinforcement signal, etc.

The measurement unit 13 may measure the vehicle speed s1 of the host vehicle 10A by the vehicle speed sensor.

The measurement unit 13 calculates the traveling azimuth angle d1 of the host vehicle 10A on the basis of the latitude and longitude of the two geographical points acquired by the positioning unit 12, but the measurement methods are not limited thereto. The measurement unit 13 may measure the traveling azimuth angle d1 of the host vehicle 10A by using a gyro-sensor.

The first determination unit 231 of the control unit 23 acquires the position information p1, the vehicle speed s1, and the traveling azimuth angle d1 from the host vehicle 10A via the communication unit 21.

In S102, the control unit 23 receives the position information p2, the vehicle speed s2, and the traveling azimuth angle d2 of the target vehicle 10B.

The control unit 23 (the first determination unit 231) of the host vehicle 10A acquires the position information p2, the vehicle speed s2, and the traveling azimuth angle d2 determined or measured by the target vehicle 10B from the target vehicle 10B via the network 2 and the communication unit 21. Note that the target vehicle 10B is a vehicle located within a range that enables inter-vehicle communication with the host vehicle 10A. In the present disclosure, the distance that enables inter-vehicle communication is assumed to be 300 m, but is not limited thereto.

In S103, the control unit 23 determines the traveling lane in which the host vehicle 10A and the target vehicle 10B are traveling from the position information of the host vehicle 10A and the target vehicle 10B and the map information.

In S104, the control unit 23 determines whether the host vehicle 10A and the target vehicle 10B are traveling in the same traveling lane. When both vehicles 10 are traveling on the same traveling lane, the process proceeds to S105, and when they are not traveling on the same traveling lane, the process proceeds to S107.

As described above, according to the quasi-zenith satellite system, the position information of the host vehicle 10A and the target vehicle 10B can be acquired with the positioning accuracy of cm class. Further, the first determination unit 231 can utilize the map information stored in the storage unit 22. Therefore, the first determination unit 231 can determine the traveling lane in which the host vehicle 10A and the target vehicle 10B travel from the acquired position information p1, p2 and the map information.

In S105, the control unit 23 determines the traveling direction of the target vehicle 10B with respect to the host vehicle 10A from differences in the traveling azimuth angles d1, d2 of the host vehicle 10A and the target vehicle 10B.

The second determination unit 232 determines whether or not the difference between the traveling azimuth angle d1 of the host vehicle 10A and the traveling azimuth angle d2 of the target vehicle 10B is equal to or greater than a threshold by the following Expression (1). When the absolute value of the difference between the traveling azimuth angles of the two vehicles 10 is equal to or larger than the threshold value, the second determination unit 232 determines that the target vehicle 10B is the reverse-traveling vehicle and proceeds to S106, and when the absolute value of the difference between the traveling azimuth angles of the two vehicles 10 is less than the threshold value, it determines that the target vehicle 10B is not the reverse-traveling vehicle and proceeds to S110.

|d2−d1|≥threshold (1)

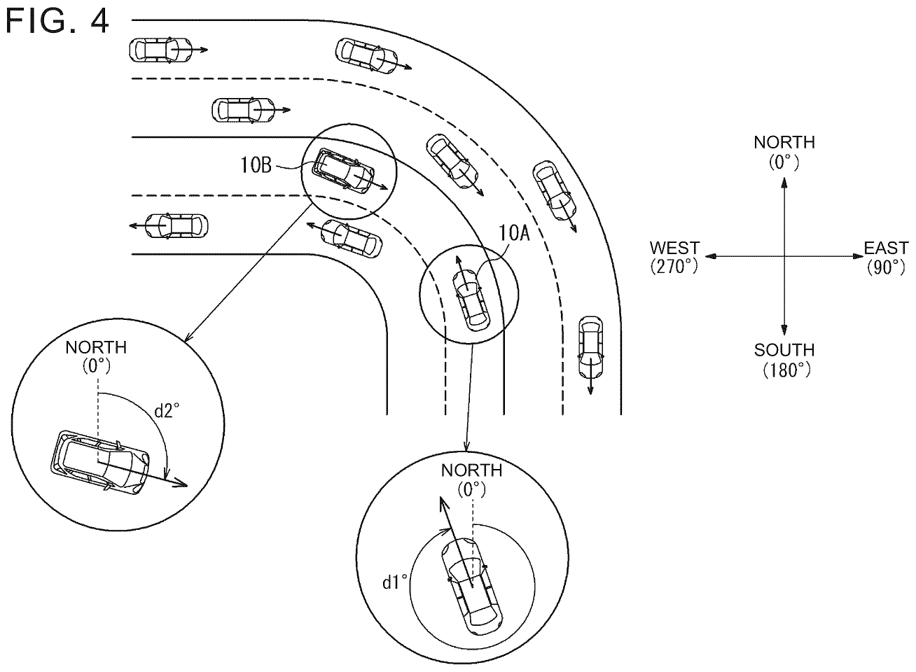

For example, as shown in FIG. 4, it is assumed that a traveling azimuth angle of 0° is north, a traveling azimuth angle of 90° is east, a traveling azimuth angle of 180° is south, and a traveling azimuth angle of 270° is west. Further, it is assumed that the target vehicle 10B is located in front of the host vehicle 10A, and both vehicles are traveling in the same traveling lane. Further, as shown in FIG. 4, in many cases, a road (traveling lane) on which both vehicles actually travel is bent. Therefore, the second determination unit 232 may calculate thresholds corresponding to the sections in which the host vehicle 10A and the target vehicle 10B travel, based on the position information and the map information of the host vehicle 10A and the target vehicle 10B. When the difference between the traveling azimuth angle d1 of the host vehicle 10A and the traveling azimuth angle d2 of the target vehicle 10B is equal to or larger than the threshold value, it is determined that the target vehicle 10B is the reverse traveling vehicle, and when the difference is less than the threshold value, it is determined that the target vehicle 10B is not the reverse traveling vehicle.

For example, it is assumed that the threshold value is calculated to be 135° in an arbitrary section. The difference between the traveling azimuth angle d1 of the host vehicle 10A and the traveling azimuth angle d2 of the target vehicle 10B is 155 degrees if the traveling azimuth angle d1 of the host vehicle 10A is 25 degrees (traveling north) and the traveling azimuth angle d2 of the target vehicle 10B is 180 degrees (traveling south) in the section. In such cases, the second determination unit 232 determines that the target vehicle 10B is a reverse-running vehicle.

In S106, the control unit 23 determines that the target vehicle 10B is a backward traveling vehicle that reversely travels in the same traveling lane as the host vehicle 10A.

In S107, the control unit 23 determines whether or not the target vehicle 10B is traveling on a traveling lane adjoining the traveling lane traveling on the host vehicle 10A. When the target vehicle 10B is traveling on an adjacent traveling lane, the process proceeds to S108, and when the target vehicle 10B is not traveling on an adjacent traveling lane, the information processing is ended.

The first determination unit 231 determines whether or not the host vehicle 10A and the target vehicle 10B are traveling in adjoining travel lanes based on the position information of the host vehicle 10A and the target vehicle 10B and the map information. When the traveling lane on which the host vehicle 10A travels and the opposite lane are adjacent to each other, the adjacent opposite lane is excluded from the determination of the adjacent traveling lane.

In S108, the control unit 23 determines whether or not the difference between the traveling azimuth angle of the host vehicle 10A and the traveling azimuth angle of the target vehicle 10B is equal to or greater than a threshold. When the difference between the traveling azimuth angles of the two vehicles 10 is equal to or greater than the threshold value, the process proceeds to S109, and when the difference is less than the threshold value, the information processing is ended.

In S109, the control unit 23 determines that the target vehicle 10B is a reverse-traveling vehicle traveling in a neighboring traveling lane.

As in S105, the second determination unit 232 calculates thresholds corresponding to the host vehicle 10A and the section in which the target vehicle 10B travels based on the position information and the map information of the host vehicle 10A and the target vehicle 10B. The second determination unit 232 may determine that the target vehicle 10B is the reverse-running vehicle when the difference between the traveling azimuth angle d1 of the host vehicle 10A and the traveling azimuth angle d2 of the target vehicle 10B is equal to or larger than the threshold value, and may determine that the target vehicle 10B is not the reverse-running vehicle when the difference is less than the threshold value. Note that the second determination unit 232 may use the same thresholds as S105 assuming that the degree of bending is the same because the traveling lanes adjoining the traveling lanes on which the host vehicle 10A travels are parallel to each other, but the present disclosure is not limited thereto. The second determination unit 232 may calculate individual thresholds between a traveling lane in which the host vehicle 10A travels and a neighboring traveling lane.

In S110, the control unit 23 determines that the target vehicle 10B is not a vehicle that reversely travels in the same traveling lane as the host vehicle 10A.

In S111, the control unit 23 outputs alert information corresponding to the determined host vehicle 10A and the traveling lane and the traveling direction of the target vehicle 10B.

The second determination unit 232 outputs the alert information to the output unit 14 of the vehicle 10. The output unit 14 outputs the alert information from the speaker by sound, or displays the alert information on the display by a character, a video, or the like. The cautionary information is, for example, “a reverse driving vehicle is in close proximity from the front. Please change the lane to the left (or right) driving lane”, “the reverse driving vehicle is approaching the adjacent driving lane from the front. Do not change the driving lane”, or “the reverse vehicle is approaching the adjacent right driving lane from the front. The lane should be changed to the left driving lane”, but the present disclosure is not limited thereto.

As described above, the information processing device 20 according to the present embodiment determines the traveling lane in which the host vehicle 10A and the target vehicle 10B travel based on the position information of the host vehicle 10A and the target vehicle 10B and the map information. The information processing device 20 determines the traveling direction of the target vehicle 10B with respect to the host vehicle 10A based on differences in the traveling azimuth angles of the host vehicle 10A and the target vehicle 10B, and outputs alert information corresponding to the determination result of the traveling direction of the traveling lane and the target vehicle 10B.

According to such a configuration, for example, the information processing device 20A can determine the host vehicle 10A and the traveling lane and the traveling direction in which the target vehicle 10B travels on a road having one or more traveling lanes, respectively, and output attention-calling information corresponding to the determination result to the output unit 14 in the vehicle cabin of the host vehicle 10A. Therefore, when the target vehicle 10B approaches the same traveling lane from the front toward the host vehicle 10A, the driver of the host vehicle 10A can detect that the target vehicle 10B traveling backward is approaching. Therefore, a technique of notifying the positional relation of the surrounding vehicle is improved in that the driver of the host vehicle 10A takes an action of avoiding danger such as lane change, thereby improving the probability of avoiding an automobile accident.

Although the present disclosure has been described above based on the drawings and the embodiments, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the information processing device 20 may be distributed among a plurality of computers capable of communicating with each other. Further, for example, an embodiment in which some or all of the components of the information processing device 20 are provided in the vehicle 10 is also possible. For example, the navigation device mounted on the vehicle 10 may include some or all of the components of the information processing device 20.

In the above-described embodiment, the information processing device 20 outputs the alert information based on the position information and the traveling azimuth angle of the host vehicle 10A and the target vehicle 10B. However, the information processing device 20 acquires the vehicle speed of the host vehicle 10A and the target vehicle 10B, and can also calculate the inter-vehicle distance from the difference between the positional information of both vehicles. Therefore, the information processing device 20 may output the alert information on the basis of other parameters such as the distance between the two vehicles or the difference in the vehicle speed. For example, even if the host vehicle 10A and the target vehicle 10B are traveling in the same direction on the same traveling lane, if the distance between the target vehicle 10B traveling in front and the host vehicle 10A is less than or equal to the predetermined distance between vehicles, it is also possible to output warning information such as “There is a risk of a collision. Open the distance between the vehicle and the preceding vehicle”. If the vehicle speed of the host vehicle 10A is higher than the target vehicle 10B traveling in the previous direction, or if the vehicle speed obtained by subtracting the vehicle speed of the target vehicle 10B from the vehicle speed of the host vehicle 10A is greater than or equal to a predetermined value, alert information such as “There is a risk of a collision. Please reduce the vehicle speed” may be output.

In the above-described embodiment, the information processing device 20 outputs the alert to the speaker or the display of the host vehicle 10A. However, the alert information may be transmitted from the information processing device 20A of the host vehicle 10A to the information processing device 20B of the target vehicle 10B by inter-vehicle communication. Due to the driver of the target vehicle 10B who runs backward on the driving lane that listens to the warning information such as “It is dangerous. Your vehicle is running backward in the running lane. Please stop on the road shoulder immediately”, it is possible to take action to avoid danger and to increase the probability of avoiding an automobile accident.

Further, an embodiment is also possible in which, for example, a general-purpose computer functions as the information processing device 20 according to the above embodiment. Specifically, a program describing processing contents for realizing each function of the information processing device 20 according to the above embodiment is stored in the memory of the general-purpose computer, and the program is read out and executed by the processor. Therefore, the present disclosure can also be realized as a program that can be executed by the processor or a non-transitory computer-readable medium that stores the program.

What is claimed is:

1. An information processing device mounted on a vehicle, the information processing device comprising a control unit that determines respective traveling lanes in which a host vehicle and a target vehicle travel from position information on the host vehicle and the target vehicle and map information, determines a traveling direction of the target vehicle with respect to the host vehicle from a difference between respective traveling azimuth angles of the host vehicle and the target vehicle, and outputs attention seeking information corresponding to a determination result of the traveling lanes and the traveling direction of the target vehicle.

2. The information processing device according to claim 1, wherein the target vehicle is a vehicle positioned within a range of a distance enabling vehicle-to-vehicle communication with the host vehicle.

3. The information processing device according to claim 1, wherein the control unit determines that the target vehicle is a wrong-way vehicle when the difference between the respective traveling azimuth angles of the host vehicle and the target vehicle is equal to or more than a threshold.

4. The information processing device according to claim 3, wherein the control unit calculates a threshold corresponding to a section in which the host vehicle and the target vehicle travel, based on the position information on the host vehicle and the target vehicle and the map information.

5. An information processing method executed by an information processing device mounted on a vehicle, the information processing method comprising:
determining respective traveling lanes in which a host vehicle and a target vehicle travel from position information on the host vehicle and the target vehicle and map information;
determining a traveling direction of the target vehicle with respect to the host vehicle from a difference between respective traveling azimuth angles of the host vehicle and the target vehicle; and
outputting attention seeking information corresponding to a determination result of the traveling lanes and the traveling direction of the target vehicle.
